(19) United States
(12) Patent Application Publication
(10) Pub. No.: US 2019/0293387 A1
(43) Pub. Date: Sep. 26, 2019

(54) TARGET ENHANCED FILTERING DEVICE

(71) Applicant: Meopta U.S.A., Inc., Trinity, FL (US)

(72) Inventors: Philip E. Buchsbaum, Oldsmar, FL (US); James D. Lane, Dunedin, FL (US)

(21) Appl. No.: 16/358,788

(22) Filed: Mar. 20, 2019

Related U.S. Application Data
(60) Provisional application No. 62/647,887, filed on Mar. 26, 2018.

(51) Int. Cl. F41G 1/30; F41G 1/473; G02B 5/20; G02B 5/22; G02B 5/26; G02B 5/28

(52) U.S. Cl. CPC F41G 1/30; F41G 1/473; G02B 5/285; G02B 5/226; G02B 5/26; G02B 5/204

(57) ABSTRACT

A rifle scope target enhancement filtration filter device wherein the ambient spectra's expected target reflected spectra is enhanced and the ambient spectra's expected background reflected spectra is lessened by thin film coatings on the plastic or glass filter is disclosed.

### CROSS-REFERENCE TO RELATED APPLICATION

The present application claims the benefit of previously filed co-pending Provisional Patent Application, Ser. No. 62/647,887, filed on Mar. 26, 2018.

### FIELD OF THE INVENTION

The method of this disclosure belongs to the field of filters for rifle scopes and other types of scopes and binoculars. More specifically it is a target enhancement filter device using thin film coatings on plastic or glass that enhances target reflected spectra and lessons background reflected spectra.

### BACKGROUND OF THE INVENTION

All hand held optical systems today, be it a rifle scope, spotting scope or binocular, are designed to maximize visual transmission so that the maximum photopic energy is observed by the user. The basic premise used by all manufacturers is that the greater the scopes photopic throughput the better the observation of targets during low light conditions. While this premise is true it does not however allow the observer a better way of discerning targets from their backgrounds. Thus there is a need for a more effective filter device having target enhancement filtration for rifle scopes and the like.

### BRIEF SUMMARY OF THE INVENTION

A rifle scope filter device having target enhancement filtration is disclosed wherein the ambient spectra's expected target reflected spectra is enhanced and the ambient spectra's expected background reflected spectra is lessened by thin film coatings on a plastic or glass filter.

### BRIEF DESCRIPTION OF THE DRAWINGS

For a fuller understanding of the nature and objects of the invention, reference should be made to the following detailed description, taken in connection with the accompanying drawings, in which:

FIG. 1 shows a diagram of the use of the target enhancement filter; and,

FIGS. 2a and 2b show diagrams of the spectral response of a forested deer hunting scene and as seen through the scope of the preferred embodiment respectively.

### DESCRIPTION OF THE PREFERRED EMBODIMENT

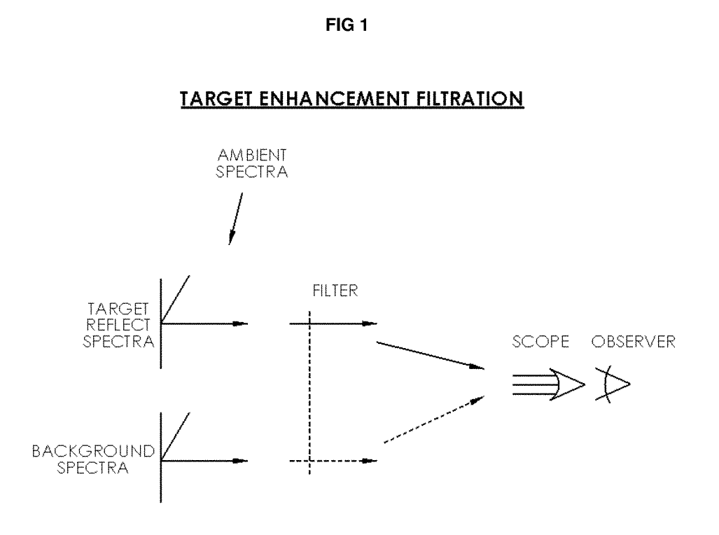

As shown in FIG. 1 the novel idea is to place an optical filter device having target enhancement filtration in accordance with this disclosure in the optical train of a rifle scope, spotting scope, binocular or other optical sighting or fire control equipment to enhance the visibility of a target being observed.

In various ambient lighting conditions objects observed in the field of view reflect different spectrums of light. By enhancing the transmission of these differentiated spectrum wherein the ambient spectra's expected target reflected spectra is enhanced and the ambient spectra's expected background reflected spectra is lessened by thin film coatings on a plastic or glass filter, it allows the observer to better discern the objects from the background's spectral reflectance. The filter device of the preferred embodiment can easily be attached or removed, such as screwed onto a standard scope, or can be incorporated into the scope's design. However, since different targets reflect differently in different ambient lighting conditions it is preferred that a series of filter devices be produced so that the user can select the filter device best matched to the expected lighting conditions, expected background, and target being observed. This can be accomplished by including, a combination of other types of filters, a plurality of similar filters, or several patterned coated filters that can be moved in such a manner that variable attenuation occurs.

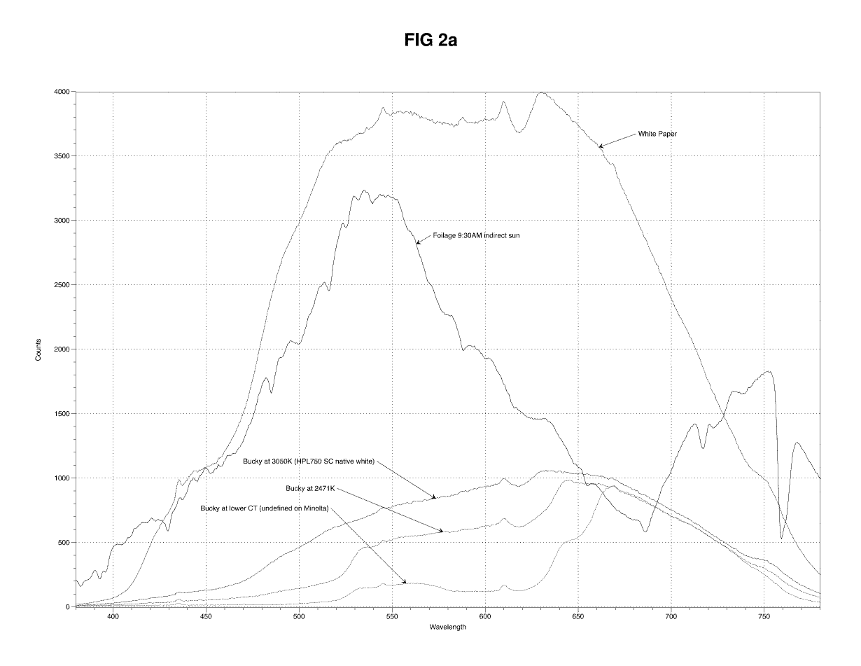

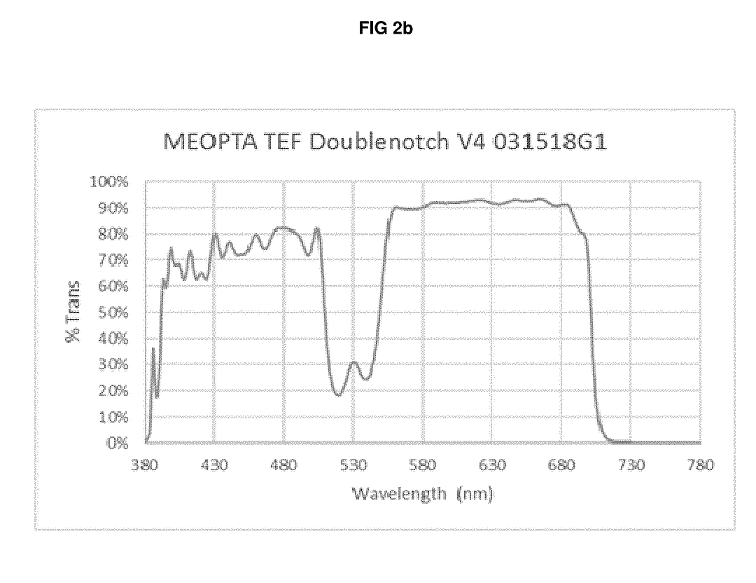

The filter device of the preferred embodiment is constructed of optical thin film coatings, either blanket or patterned, on plastic or glass that specifically differentiate the optic spectrum in favor of the spectra reflecting off of the target being observed as opposed to the spectra reflecting off the background. For example a specific embodiment may be a thin film coated optical filter device made of plastic or glass incorporating target enhancement filtration to be used for deer (Bucky) hunting in a forested area having the spectral response shown in FIG. 2a wherein the filter balances the reflected light spectra that the observer sees by suppressing the background thus increasing the visibility of the target to the observer as shown in FIG. 2b.

Since certain changes may be made in the above described target enhancement filtration device having a thin film coating on a plastic or glass filter in rifle scopes to improve target acquisition without departing from the scope of the invention herein involved, it is intended that all matter contained in the description thereof or shown in the accompanying figures shall be interpreted as illustrative and not in a limiting sense.

What is claimed is:

1. A target enhancement filtration filter device for placement in an optical train of a rifle scope, spotting scope, binocular or other optical sighting or fire control equipment comprising:
a plastic or glass filter; and,
an optical coating on said plastic or glass filter that enhances the ambient spectra's expected target reflected spectra and lessens the ambient spectra's expected background reflected spectra.

2. The target enhancement filtration filter device of claim 1 wherein said coatings are thin film coatings that specifically differentiate the optic spectrum of said filter in favor of the spectra reflecting off of a target being observed when compared to the spectra reflecting off the background.

3. The target enhancement filtration filter device of claim 2 wherein said filter device is removeably insertable into said optical train.

4. The target enhancement filtration filter device of claim 3 that includes a combination of other types of filters.

5. The target enhancement filtration filter device of claim 4 that includes a plurality of said filter devices.

6. The target enhancement filtration filter device of claim 5 wherein said coatings are patterned such that said coatings create variable attenuation when used with said plurality of filter devices or other filter devices.
